(19) United States
(12) Patent Application Publication
(10) Pub. No.: US 2009/0327187 A1
(43) Pub. Date: Dec. 31, 2009

(54) CONNECTIVITY IN A PEER NETWORK

(75) Inventors: Raymond Lo, Mountain View, CA (US); Angel X. Chang, Sunnyvale, CA (US); Steven J. Onorato, Mountain View, CA (US)

Correspondence Address: PERKINS COIE LLP, P.O. BOX 1208, SEATTLE, WA, 98111-1208, US

(73) Assignee: BroadOn Communications Corp., Mountain View, CA (US)

(21) Appl. No.: 12/202,179

(22) Filed: Aug. 29, 2008

Related U.S. Application Data
(60) Provisional application No. 61/075,732, filed on Jun. 25, 2008.

(51) Int. Cl. G06N 5/02; G06F 15/16; H04L 9/32

(52) U.S. Cl. 706/46; 709/238; 709/230; 726/5

(57) ABSTRACT

Improving connectivity in a peer-to-peer (P2P) network involves packet forwarding by infrastructure or peers. A system can achieve full connectivity and a setup for transactions that takes a fraction of a second. The system can include a routing table that is initially configured so that packets to peers are routed via the infrastructure. NAT traversal heuristics can be employed to establish direct connections between peers in parallel with packet forwarding in accordance with the routing table. When a direct connection is ready, the routing table can be updated so that packets are sent P2P. If a direct connection cannot be made, the routing table can be updated so that the packets are sent through a peer intermediary without going through the infrastructure.

### CROSS-REFERENCE TO RELATED APPLICATION

This Application claims priority to U.S. Provisional Patent Application No. 61/075,732, filed Jun. 25, 2008, and entitled “CONNECTIVITY IN A PEER NETWORK”, which is incorporated herein by reference.

### BACKGROUND

There are limitations with network address translation (NAT). One such limitation is that connectivity is not guaranteed. For example, given two peers behind firewalls, it might not be possible to create a direct connection regardless of how hard and how long an application tries. Another limitation is that NAT traversal (NAT-T) algorithms take time to execute. There is a direct correlation between the number of cases a NAT-T algorithm can cover, and the time it takes to set up and/or traverse paths. So there is a tradeoff between desired connectivity and delay.

As with any transmission across a network, particularly bandwidth-constrained networks, such as wireless, there are continuous efforts to develop more efficient techniques to reduce bandwidth requirements. Even on relatively unconstrained networks, improved transmission techniques can improve speed and/or reduce hardware costs. So research and development continues industry-wide in many areas of traffic management and network connectivity.

The foregoing examples of the related art and limitations related therewith are intended to be illustrative and not exclusive. Other limitations of the related art will become apparent upon a reading of the specification and a study of the drawings.

### SUMMARY

The following examples and aspects thereof are described and illustrated in conjunction with systems, tools, and methods that are meant to be exemplary and illustrative, not limiting in scope. In various examples, one or more of the above-described problems have been reduced or eliminated, while other examples are directed to other improvements.

A technique for improving connectivity in a peer-to-peer (P2P) network involves packet forwarding by infrastructure or peers. A system implementing this technique can achieve full connectivity with properly configured devices (assuming a properly functioning environment) and a setup for transactions that takes a fraction of a second. In a specific implementation, the system includes a routing table that is initially configured so that packets to peers are routed via the infrastructure. Advantageously, this enables peers to establish communications quickly. NAT traversal heuristics can be employed to establish direct connections between peers in parallel with packets forwarded in accordance with the routing table. When a direct connection is ready, the routing table can be updated so that packets are sent P2P or through a peer intermediary without going through the infrastructure.

These and other advantages will become apparent to those skilled in the relevant art upon a reading of the following descriptions and a study of the several examples of the drawings.

### BRIEF DESCRIPTION OF THE DRAWINGS

The following figures are intended to illustrate by way of example some aspects of techniques described in this paper.

FIG. 1 depicts an example of a system capable of fast P2P connectivity.

FIG. 2 depicts an example of a system for optimized routing in a P2P network.

FIG. 3 depicts a flowchart of an example of a method for efficient P2P routing.

FIG. 4 depicts an example of a system with data source authentication.

FIG. 5 depicts an example of a system establishing connections between two devices inside the same firewall.

FIG. 6 depicts an example of a system 600 that uses a peer coordinator to set up a connection through a peer intermediary.

FIG. 7 depicts an example of a computer system.

### DETAILED DESCRIPTION

In the following description, several specific details are presented to provide a thorough understanding. One skilled in the relevant art will recognize, however, that the concepts and techniques disclosed herein can be practiced without one or more of the specific details, or in combination with other components, etc. In other instances, well-known implementations or operations are not shown or described in detail to avoid obscuring aspects of various examples disclosed herein.

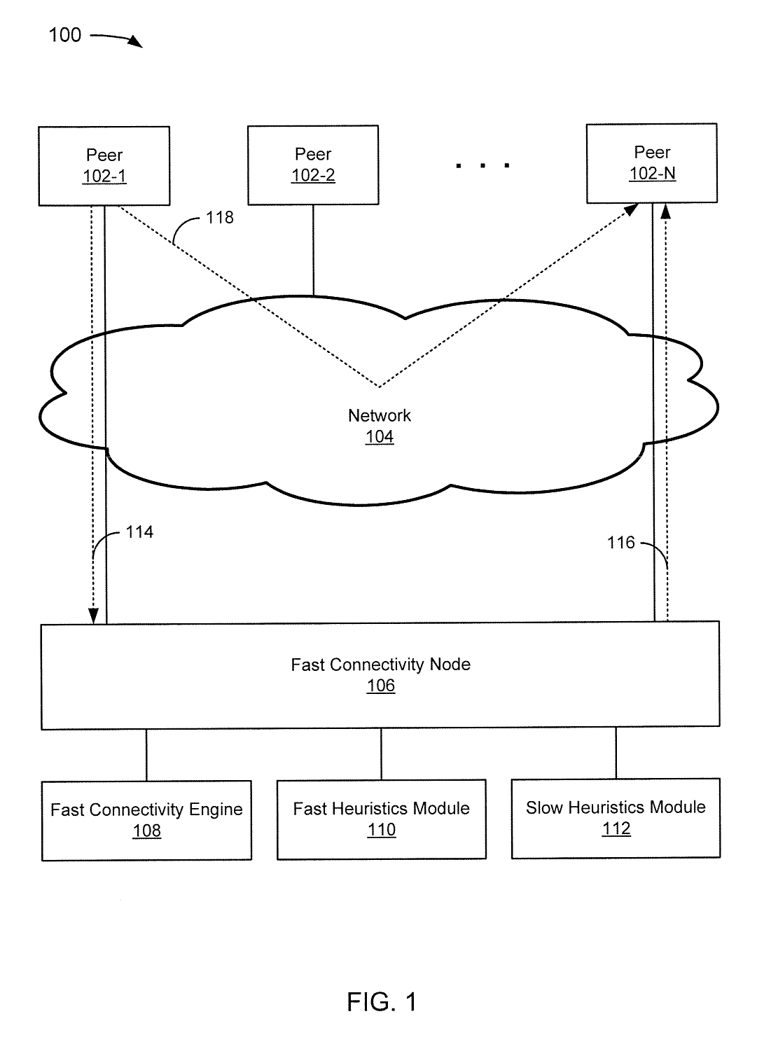

FIG. 1 depicts an example of a system 100 capable of fast peer-to-peer (P2P) connectivity. The system 100 includes peers 102-1 to 102-N (referred to collectively as peers 102), a network 104, a fast connectivity (FC) node 106, a FC engine 108, a fast heuristics module 110, and a slow heuristics module 112.

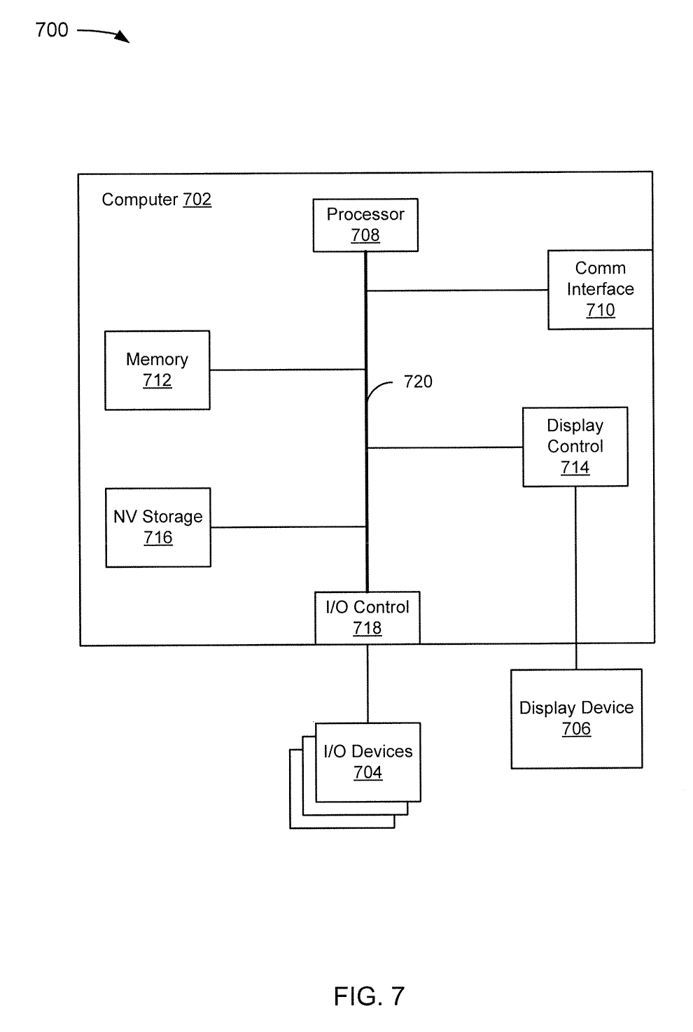

The peers 102 can be implemented as software embodied in a computer-readable medium, firmware, hardware, or a combination thereof. The implementation can be on a general purpose computer (see FIG. 7), a special purpose computer, a logic device (e.g., a PLA), or any other applicable known or convenient device or system. The peers 102 include software embodied in a computer-readable medium, firmware, hardware, or a combination thereof that enable the peers 102 to connect to a P2P network. A first of the peers 102 is capable of sending data to and/or receiving data from a second of the peers 102.

It should be noted that a person of skill in the relevant art would have no difficulty understanding what is meant by the term “computer-readable medium.” To the extent legal interpretation introduces ambiguity, it should be understood that the intention in this paper is to encompass all statutory computer-readable media and to exclude nonstatutory interpretations of the term “computer-readable medium” to the extent it is necessary to preserve claim validity. Further, if the law changes, the term computer-readable medium should be interpreted consistent with the law of the time. Since the law is presumably unambiguous at any given time, such as today, the meaning of the term “computer-readable medium” is both clear to one of skill in the relevant art and not ambiguous to one with knowledge of the law since the definition encompasses only computer-readable media that is allowed under the law, no more and no less.

The network 104 couples the peers 102 together. The network 104 can be implemented as one or more network devices. The devices can be implemented as software embodied in a computer-readable medium, firmware, hardware, or a combination thereof. The implementation can be on a general purpose computer (see FIG. 7), a special purpose computer, a logic device (e.g., a PLA), or any other applicable known or convenient device or system. The network 104 may include the Internet and/or other networks that couple devices together, whether or not the devices are peers. Since the peers 102 are coupled to the network 104, the network 104 is also by definition at least in part a P2P network.

In a specific implementation, the network 104 is initially configured to forward data from the peers 102 to the FC node 106. This may be accomplished using any applicable known or convenient technique, such as routing tables, switches, etc.

The FC node 106 is coupled to the network 104. The FC node 106 can be implemented as software embodied in a computer-readable medium, firmware, hardware, or a combination thereof. The implementation can be on a general purpose computer (see FIG. 7), a special purpose computer, a logic device (e.g., a PLA), or any other applicable known or convenient device or system. The FC node 106 can be implemented on a device such as a server, router, switch, relay, internetworking gateway, controller, or other network device, which is coupled to the network 104 and through the network 104 to some or all of the peers 102, but it need not be implemented on any such device.

In a specific implementation, the FC node 106 is on a server, and establishing a connection through the FC node 106 consumes server bandwidth. The term server, as used in this example, is intended to include providing services sufficient to connect peers through the FC node 106. The server could, of course, provide other services, as well.

The FC engine 108 is coupled to the FC node 106. The FC engine 108 can be implemented as software embodied in a computer-readable medium, firmware, hardware, or a combination thereof. The implementation can be on a general purpose computer (see FIG. 7), a special purpose computer, a logic device (e.g., a PLA), or any other applicable known or convenient device or system. The FC engine 108 can be implemented on a device such as a router, switch, relay, internetworking gateway, controller, or other network device, which is coupled to the network 104 and through the network 104 to some or all of the peers 102, but it need not be implemented on any such device. In operation, an engine includes both a computer-readable medium having instructions generated thereon to accomplish the functionality of the engine, and a processor for executing the instructions. Advantageously, when the FC engine 108 facilitates a P2P connection between the peers 102, it is no longer necessary to consume bandwidth at the FC node 106.

The FC engine 108 is capable of using the fast heuristics module 110 to establish a connection with a first peer (e.g., the peer 102-1). The fast heuristics module 110 could be implemented on one or more of the peers 102, in the network 104, on the FC node 106, as part of the FC engine 108, or as a distinct component as depicted in the example of FIG. 1, though it is depicted as a distinct component for illustrative purposes only. Advantageously, a fast heuristic typically scales with the number of peers 102, reduces setup delay, eliminates denial following a delay while attempting to use a slow heuristic, and can punch through firewalls. The reason a fast heuristic can scale with the number of peers 102 is that the fast heuristic can be run in parallel for all of the peers 102, rather than serially for each of the peers 102 in turn.

As has been mentioned, there is no requirement that the fast heuristics module 110 actually be “at” the FC node 106 or the FC engine 108, and could be implemented by configuring the network 104 appropriately. For example, the FC engine 108 could initially configure routing tables associated with the network 104 to route packets from the peers 102 through the FC node 106. In such a case, at least logically, the routing table entries could be considered part of the fast heuristics module 110. It follows that in some embodiments the FC engine 108 configures the fast heuristics module 110, and packets are routed in accordance with the configuration of the fast heuristics module 110.

The FC engine 108 is capable of using the slow heuristics module 112 to establish a P2P connection between the first peer and a second peer (e.g., the peer 102-N). The slow heuristics module 112 could be implemented on one or more of the peers 102, in the network 104, on the FC node 106, as part of the FC engine 108, or as a distinct component as depicted in the example of FIG. 1, but is depicted as a distinct component for illustrative purposes. The slow heuristics module 112 includes one or more slow heuristics, which can be run in parallel with the fast heuristics module 110. Although slow heuristics can be run in parallel with fast heuristics, it should be understood that each slow heuristic is slow because some slow heuristics cannot be run in parallel for each of the peers 102, and some heuristics involve a substantial amount of packet exchange with each of the peers 102.

As the names suggest, the fast heuristics should enable a connection more quickly than the slow heuristics. Since the fast and slow heuristics are run in parallel, the first peer will not have to wait for the slow heuristic to get results. Also, slow heuristics are not always effective so the first peer will not have to wait for the slow heuristic to complete only to find that no connection is possible with the slow heuristic (it may even be that no slow heuristic works).

In a specific implementation, the FC engine 108 selects a slow heuristic using knowledge about the peers 102 (and in particular about firewalls at the peers 102). Such knowledge may be collected during a registration process and/or from detected operations. The FC engine 108 can use the knowledge to select optimal heuristics to shorten the total setup time.

In the example of FIG. 1, in operation, the FC engine 108 uses the fast heuristics module 110 to open a path between a first peer (e.g., the peer 102-1) and the FC node 106. This path is represented as the arrow 114 in FIG. 1. The FC engine 108 uses the fast heuristics module to open a path between the FC node 106 and a second peer (e.g., the peer 102-N). This path is represented as the arrow 116 in FIG. 1. After the first peer has established a path through the FC node 106 to the second peer, the FC engine 108 uses the slow heuristics module 112 to establish a path through the network 104 to the second peer that bypasses the FC node 106. This path is represented as the arrow 118 in FIG. 1. Note that it is equivalent to say a peer “uses the fast/slow heuristics module,” rather than the FC engine 108. For illustrative purposes, the FC engine 108 is referred to as taking the actions, and this is accurate in any implementation because the FC engine 108 can be distributed across the peers 102 and/or other devices.

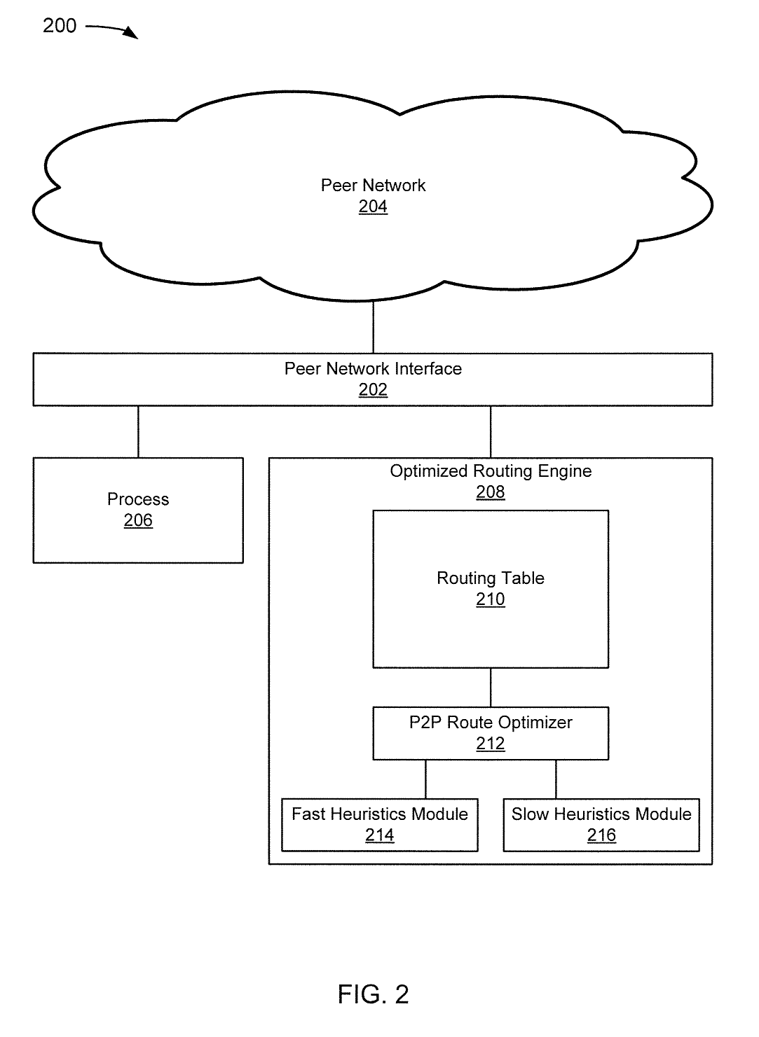

FIG. 2 depicts an example of a system 200 for optimized routing in a P2P network. The system 200 includes a peer network interface 202, a peer network 204, a process 206, and an optimized routing engine 208. In the example of FIG. 2, the peer network interface 202 couples the peer network 204 to the process 206 and the optimized routing engine 208.

In the example of FIG. 2, the peer network interface 202 can be implemented as software embodied in a computer-readable medium, firmware, hardware, or a combination thereof. The implementation can be on a general purpose computer (see FIG. 7), a special purpose computer, a logic device (e.g., a PLA), or any other applicable known or convenient device or system. The function of the peer network interface 202 is to couple a device to a peer network, and it may do so in any applicable known or convenient manner.

In the example of FIG. 2, the peer network 204 is intended to represent a plurality of peers coupled together in any applicable known or convenient manner.

In the example of FIG. 2, the process 206 is intended to represent a process that is executing at a device coupled to the peer network 204 through the peer network interface 202. The process 206 can be implemented as software embodied in a computer-readable medium, firmware, hardware, or a combination thereof. The implementation can be on a general purpose computer (see FIG. 7), a special purpose computer, a logic device (e.g., a PLA), or any other applicable known or convenient device or system. For illustrative purposes, the process 206 can, through the peer network interface 202, receive packets from the peer network 204 and send packets to the peer network 204.

In the example of FIG. 2, the optimized routing engine 208 includes a routing table 210, a P2P route optimizer 212, a fast heuristics module 214, and a slow heuristics module 216. The optimized routing engine 208 can be implemented as software embodied in a computer-readable medium, firmware, hardware, or a combination thereof. The implementation can be on a general purpose computer (see FIG. 7), a special purpose computer, a logic device (e.g., a PLA), or any other applicable known or convenient device or system. For illustrative purposes, the optimized routing engine 208 is coupled to the peer network 204 through the same peer network interface 202 as the process 206. In some implementations, the process 206 and the optimized routing engine 208 are implemented on the same device and they share a particular interface. In other implementations, the optimized routing engine 208 is implemented on a device that does not include the process 206 (in this case, the peer network interface 202 can include two distinct interfaces that are represented as one for illustrative purposes only).

In the example of FIG. 2, the routing table 210 is intended to represent a standard routing table implemented as is convenient. The term “routing table” is sometimes used to refer to a router for Layer 3, the network layer, of the open systems interconnection (OSI) model. While an implementation of the routing table 210 is on the network layer, it should be understood that similar functionality is possible on a different layer, such as Layer 2, the data link layer. The use of a routing table to route packets from a source to a destination is well-understood in the relevant art, and is not described in significant detail in this paper. It is worth noting that the term “packet” is sometimes used to refer to data that is sent at the network layer, and sometimes used to refer to data that is sent at the data link layer. Therefore, the term “packet,” can be used to refer to either L3 packets or L2 frames, depending upon the context.

In the example of FIG. 2, the P2P route optimizer 212 is coupled to the routing table 210, the fast heuristics module 214, and the slow heuristics module 216. In a specific implementation, the P2P route optimizer 212 can execute a fast heuristic of the fast heuristics module 214 and a slow heuristic of the slow heuristics module 216 in parallel. The fast heuristic is almost always faster than the slow heuristic (hence the name). So, typically, the P2P route optimizer 212 will execute the fast heuristic and update the routing table 210 in accordance with the results of the execution of the fast heuristic before execution of the slow heuristic is complete. Later, if the execution of the slow heuristic is successful, the P2P route optimizer 212 can update the routing table 210 in accordance with the results of the execution of the slow heuristic.

In the example of FIG. 2, in operation, the process 206 indicates an intention to send a message to a peer in the peer network 204. The P2P route optimizer 212 executes a fast heuristic in the fast heuristics module 214 and updates the routing table 210 in accordance with the results of the execution of the fast heuristic. The optimized routing engine 208 sends a packet including the message through the peer network interface 202 to the peer.

In the meantime, the P2P route optimizer 212 executes a slow heuristic in the slow heuristics module 216. The P2P route optimizer 212 may begin to execute the fast and slow heuristics at the same time (i.e., in parallel), or it may execute the fast heuristic first. While it is not prohibited to execute the slow heuristic first, it may defeat the purpose of getting the results of a fast heuristic quickly, to establish connectivity quickly, if the slow heuristic is executed for any significant amount of time prior to execution of the fast heuristic. In any case, at some point execution of the slow heuristic ends. If the slow heuristic ends with success, the P2P route optimizer 212 updates the routing table 210 in accordance with the results of the execution of the slow heuristic.

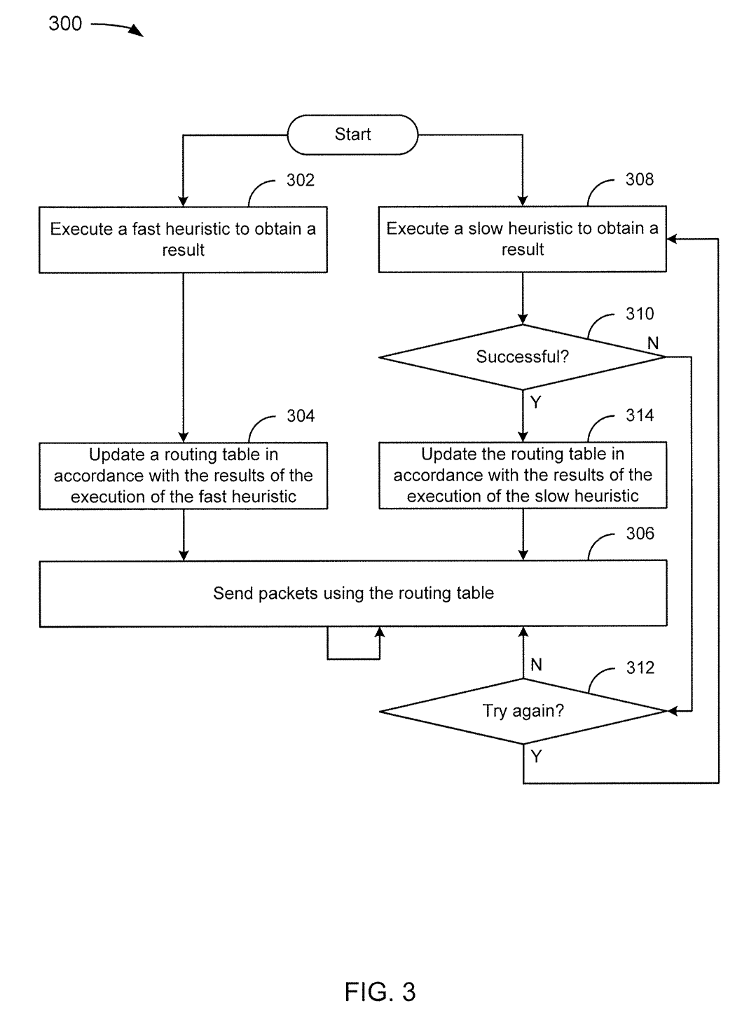

FIG. 3 depicts a flowchart 300 of an example of a method for efficient P2P routing. The flowchart 300 is organized as a sequence of modules. However, it should be understood that these, and modules associated with other methods described herein, may be reordered into different sequences of modules or for parallel execution.

In the example of FIG. 3, the flowchart 300 starts at module 302 (and at module 308, which is discussed later) with executing a fast heuristic to obtain a result. The fast heuristic will find an easy path over which to send packets. In a typical implementation, the easy path is a predetermined path, such as a path to a packet forwarding device that serves as an intermediary between a sender of a packet and the recipient. Since the path is an easy one, the fast heuristic has a high likelihood of success and setup time to establish the path is relatively small.

In the example of FIG. 3, the flowchart 300 continues to module 304 with updating a routing table in accordance with the results of the execution of the fast heuristic and to module 306 with sending packets using the routing table. The flowchart 300 loops back to the module 306 as long as there are packets to send.

In the example of FIG. 3, the flowchart 300 not only starts at module 302, but also at module 308 with executing a slow heuristic to obtain a result. Executing the slow heuristic lags in time behind executing the fast heuristic (module 302), even if the fast and slow heuristics are executed in parallel. Of course, if the fast heuristic is executed before the slow heuristic, the slow heuristic will lag even further, but the flowchart 300 works whether the fast and slow heuristics are executed in parallel or the slow heuristic is executed after the fast heuristic is executed to completion.

In the example of FIG. 3, following module 308, the flowchart 300 continues to decision point 310 where it is determined whether the slow heuristic executed successfully. If it is determined that the slow heuristic did not execute successfully (310-N), then the flowchart 300 continues to decision point 312 where it is determined whether to try again. If it is determined to try again (312-Y), then the flowchart 300 continues to module 308 as described previously. Note that if you fail to punch through a firewall or run into some other problem, you may have to try many slow heuristics and the wait can be long (and the end result may be that you try everything and still fail). If, on the other hand, it is determined not to try again, then the flowchart 300 continues to module 306 and loops as long as there are additional packets to send, as described previously. Notably, in this case, the routing table keeps the values provided in accordance with the results of the execution of the fast heuristic (unless changed by some other process). It may be noted that slow heuristics tend to have lower probability of success than fast heuristics for various reasons (e.g., slow heuristics tend to be inferior at punching through firewalls).

In the example of FIG. 3, if it is determined that the slow heuristic executed successfully (310-Y), then the flowchart continues to module 314 with updating the routing table in accordance with the results of the execution of the slow heuristic. Since the fast heuristic was executed to completion prior to the execution of the slow heuristic to completion, the update following execution of the slow heuristic occurs after the update following execution of the fast heuristic. It may be noted that the use of metrics and multiple table entries may make the order of updating practically irrelevant. For example, the fast heuristic may establish a path through a server, while the slow heuristic may establish a P2P path between peers. After module 314, the flowchart 300 continues to module 306 and loops as described previously.

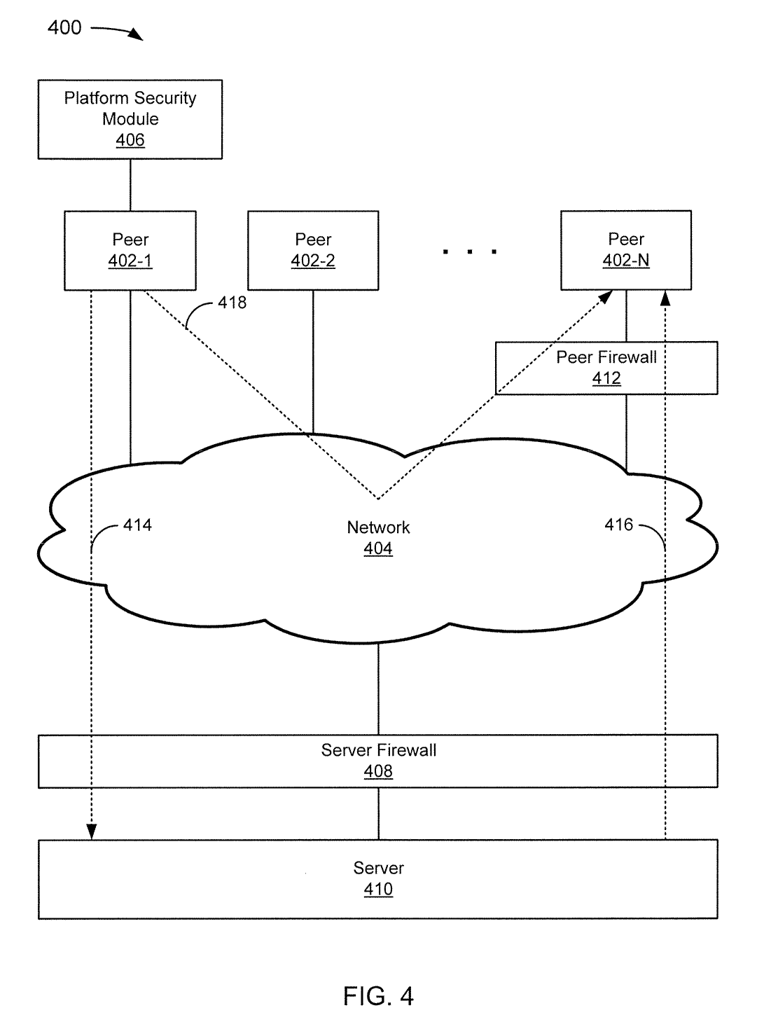

FIG. 4 depicts an example of a system 400 with data source authentication. In the example of FIG. 4, the system 400 includes peers 402-1 to 402-N (referred to collectively as peers 402), a platform security module 404, a network 406, a server server firewall 408, a server 410, and a peer firewall 412. It should be noted that the peer 402-1 (or any of the other peers 402) may or may not have a firewall, but an optional firewall for the peer 402-1 (or any of the other peers 402 besides the peer 402-N) is not depicted in the example of FIG. 4 because it is not necessary for illustrative purposes.

The peers 402 are coupled to the network 404, all of which can be similar to peers and networks described previously (see, e.g., FIG. 1). However, in addition, at least one of the peers 402 (in the example of FIG. 4, peer 402-1) is coupled to the platform security module 406. The platform security module 406 can be implemented as software embodied in a computer-readable medium, firmware, hardware, or a combination thereof. The implementation can be on a general purpose computer (see FIG. 7), a special purpose computer, a logic device (e.g., a PLA), or any other applicable known or convenient device or system. In some real-world implementations, infrastructure packet forwarding would not be practical without data source authentication. For example, if a company introduces a P2P forwarding server without client authentication, Internet users may find out and start using the packet forwarding servers for other P2P services, eventually overloading the packet forwarding servers.

In the example of FIG. 4, the platform security module 406 can include a certificate. In a specific implementation, the certificate provides a trusted identity for the peer 402-1. In another implementation, the certificate provides a trusted identity for a device associated with the peer 402-1. In another specific implementation, the certificate provides a trusted identity for a process running in association with the peer 402-1.

Using the certificate, the peer 402-1 can punch through the server firewall 408 to reach the server 410. For the purposes of this example, the server firewall 408 keeps the peers 402 that do not have a trusted identity from utilizing at least packet forwarding services provided by the server 410. Thus, in a specific implementation, by “trusted identity” what is meant is the server 410 provides packet forwarding (and/or other) services to the peer 402-1 when the peer 402-1 identifies itself as a trusted party using the certificate in a data source authentication process. Data source authentication can involve known or convenient techniques to establish secure communications between the peer 402-1 and the server 410, such as generating an authentication key and using the authentication key to authenticate packets exchanged between the peer 402-1 and the server 410.

In a specific implementation, the server 410 is a non-peer server that provides services to the peers 402. In another specific implementation, the server 410 is a peer server that provides services to the peers 402. In this implementation, the server 410 is really just another peer (like the peers 402), and others of the peers 402 could have similar functionality (i.e., provide packet forwarding services). For the purposes of this paper, where a distinction between a non-peer server and a peer server is desired, they are referred to as such. The term “server” without a modifier is intended to cover both non-peer servers and peer servers, unless the context dictates otherwise.

Assuming the peer 402-1 has a trusted identity, the server 410 will forward packets to one or more of the other peers 402 (the peer 402-N in the example of FIG. 4). The server 410 must be able to punch through the peer firewall 412 to reach the peer 402-N. This is not difficult, and can be accomplished in any applicable known or convenient manner (e.g., using a fast heuristic). It should be noted, however, that the peer 402-1 might have a difficult time punching through the peer firewall 412, depending upon the peer firewall 412 settings and/or other factors.

Packet forwarding at the server 410 will naturally consume infrastructure bandwidth and/or other resources. Accordingly, it may be desirable to facilitate a P2P connection between the peer 402-1 and the peer 402-N to force the peers to consume peer resources, rather than infrastructure resources. When the term “infrastructure” is used in this paper, what is meant is the server and other components (e.g., data pipes). Infrastructure is significant because enterprises will often wish to protect infrastructure resources. For example, an enterprise may refuse to forward packets if the packets do not have proper authentication. Similarly, enterprises often value infrastructure bandwidth higher than peer bandwidth, and opt to push bandwidth consumption off to peers where it is possible to do so. In a specific implementation, the authentication scheme that is used to authenticate packets at the server 410 can be used both between peer and infrastructure and between peers, and the security can be the same whether packets are forwarded using infrastructure resources or peer resources.

In the example of FIG. 4, in operation, the peer 402-1 uses the platform security module 406 to punch through the server firewall 408 to the server 410 using a secure protocol. The server 410 can punch through the peer firewall 412 to reach the peer 402-N. The peer 402-1 can then make use of packet forwarding services provided by the server 410 to send packets across the network 404 to the server 410, which is represented in the example of FIG. 4 by the arrow 414. The server 410 sends the packets across the network 404 to the peer 402-N, which is represented in the example of FIG. 4 by the arrow 416. Advantageously, the server 410 can establish trust between the peers 402-1 and 402-N, and the peer 402-1 can switch to P2P, which is represented in the example of FIG. 4 by the arrow 418, thereby reducing or eliminating its consumption of infrastructure resources at the server 410.

Sometimes peers do not have firewalls, in which case establishing connections between them is relatively easy, and sometimes peers have firewalls. When peers behind firewalls attempt to form a connection, the processes described above can be used. However, occasionally peers will be behind the same firewall. In such a case, a system can attempt one or both of a hairpin path or an internal path.

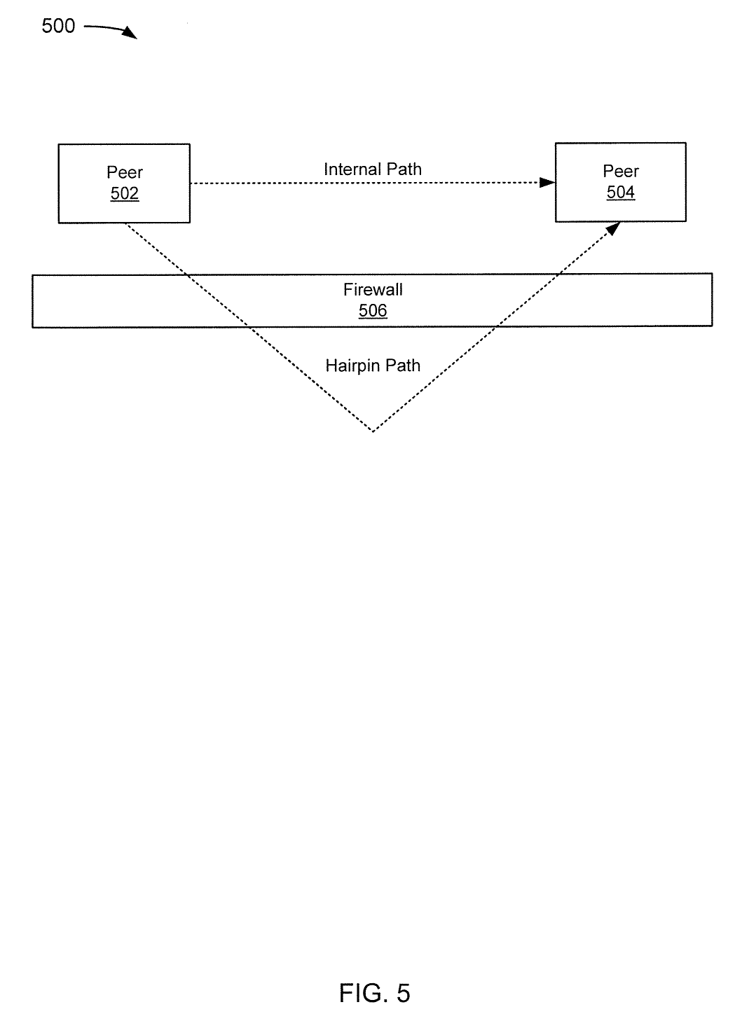

FIG. 5 depicts an example of a system 500 establishing connections between two devices inside the same firewall. In the example of FIG. 5, the system 500 includes a peer 502, a peer 504, and a firewall 506. The peer 502 has a first internal Internet Protocol (IP) address and the peer 504 has a second internal IP address. The peer 502 can attempt to establish an internal path with the peer 504, as illustrated in the example of FIG. 5. If this path is allowed, which will depend upon the configuration of the system 500, it is typically a fast and reliable connection.

The peer 502 can also attempt to establish a hairpin path with the peer 504 by going outside of the firewall 506, and then back in. The peer 502 has a first public IP address and the peer 504 has a second public IP address. Relative to the internal path using internal IP addresses, the hairpin path using public IP addresses is potentially slower and less reliable. So, if the internal path is allowed, it is typically preferable to the hairpin path.

The configuration (potentially including a “default” configuration that may colloquially be referred to as “unconfigured”) of the system 500 will determine whether the internal path or the hairpin path is allowed. The system 500 can be configured to allow the internal path, the hairpin path, or both. Since it is possible that the internal path is not allowed, it may be desirable to attempt both paths in parallel to reduce the setup delay when establishing a connection between the peer 502 and the peer 504 in the event the internal path is not allowed.

Sometimes peers cannot establish P2P connections. That is, a connection coordinator can connect the peers with a fast heuristic, but cannot find a valid direct connection with a slow heuristic. In this case, it is still possible to conserve infrastructure resources by establishing an intermediary peer to do packet forwarding. It should be noted that the term “peer” is still used in this paper, even though the peers cannot establish a P2P connection, because the peers are on a peer network that is capable of P2P communications.

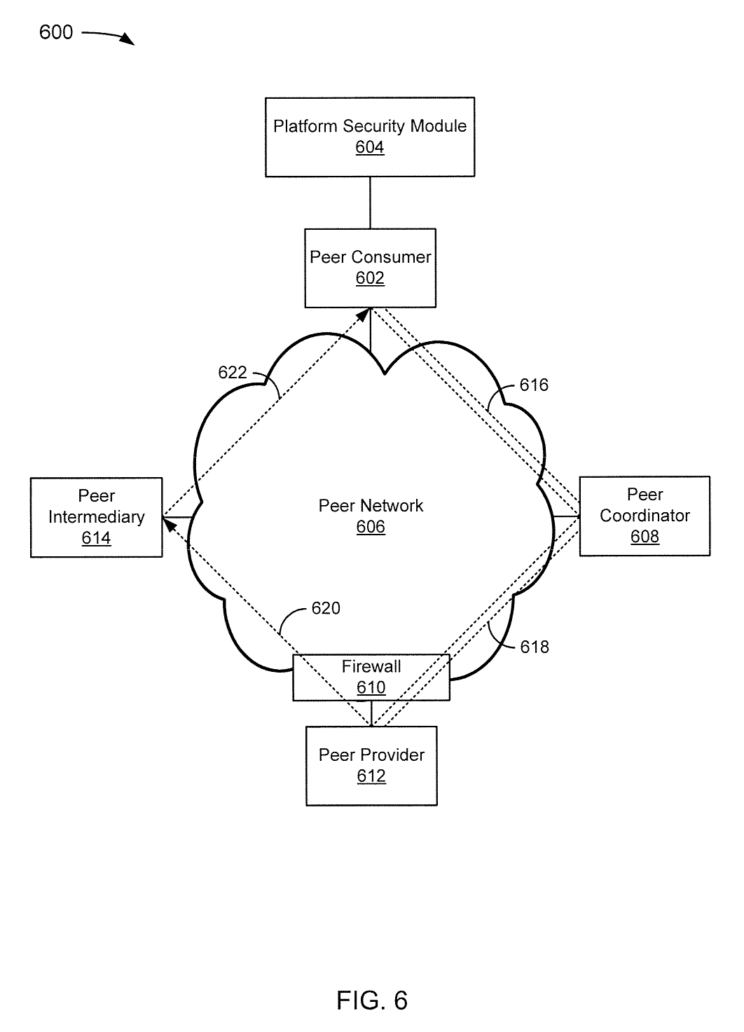

FIG. 6 depicts an example of a system 600 that uses a peer coordinator to set up a connection through a peer intermediary. In the example of FIG. 6, the system 600 includes a peer consumer 602, a platform security module 604, a peer network 606, a peer coordinator 608, a firewall 610, a peer provider 612, and a peer intermediary 614.

The peer consumer 602 can be similar to a peer described previously (see, e.g., FIG. 4), or some other applicable known or convenient peer. The “consumer” designation is for illustrative purposes and is not intended to denote a special kind of peer, but rather a peer that currently in the process of obtaining content from another peer for consumption.

The platform security module 604 can be similar to a platform security module described previously (see, e.g., FIG. 4), or some other applicable known or convenient security module. In the example of FIG. 4, the platform security module 604 is coupled to the peer consumer 602. It should be noted that other peers in the system 600 could be coupled to the platform security module 604 as well, but the optional platform security modules are omitted because they are not useful for illustrative purposes.

The peer network 606 can be similar to a peer network as described previously (see, e.g., FIG. 4), or some other applicable known or convenient network capable of P2P connections for at least some peers coupled to the peer network 606. The peer consumer 602 is coupled to the peer network 606.

The peer coordinator 608 is also coupled to the peer network 606. The peer coordinator 608 can include a server, a peer, or some other applicable known or convenient device capable of facilitating a connection between the peer consumer 602 and some other peer on the peer network 606.

The firewall 610 is coupled to the peer network 606. Advantageously, the firewall 610 does not have to be specially or specifically configured. Where it is desirable to indicate that a firewall is not specially configured for the system 600, the firewall may be referred to as an “unspecified firewall.” With a properly configured registration (e.g., a data authentication process) or other peer management system coupled to the peer coordinator 608, an unspecified firewall can be used.

The peer provider 612 sits behind the firewall 610 and is coupled to the peer network 606 through the firewall 610. The peer provider 612 can be similar to a peer described previously (see, e.g., FIG. 4), or some other applicable known or convenient peer. The “provider” designation is for illustrative purposes and is not intended to denote a special kind of peer, but rather a peer that is currently in the process of providing content to another peer for consumption.

The peer intermediary 614 is coupled to the peer network 606. The peer intermediary can be similar to a peer described previously (see, e.g., FIG. 4), or some other applicable known or convenient peer. The “intermediary” designation is for illustrative purposes and is not intended to denote a special kind of peer, but rather a peer that is currently in the process of forwarding packets from one peer to another peer.

In the example of FIG. 6, in operation, the peer consumer 602 uses the platform security module 604 to establish a secure connection across the peer network 606 to the peer coordinator 608. The secure connection (i.e., a connection using a secure protocol) is represented as a pipe 616 in the example of FIG. 6. It should be noted that in a practical secure implementation, the pipe 616 is typically associated with a secure protocol, but some other protocol could be used in an implementation that does not have need for a secure connection between the peer consumer 602 and the peer coordinator 608.

In the example of FIG. 6, in operation, the peer coordinator 608 punches through the firewall 610 to establish a connection to the peer provider 612. The connection is represented as a pipe 618 in the example of FIG. 6. It is not necessarily important that the connection from the peer coordinator 608 use a secure protocol because the system 600 can be reasonably secure even if the connection between the peer coordinator 608 and the peer provider 612 is associated with a protocol that is not considered a secure protocol.

In the example of FIG. 6, in operation, the peer coordinator 608 may or may not forward packets from the peer provider 612 to the peer consumer 602 via the connection (616, 618). In a specific implementation, one or more slow heuristics are executed while the peer coordinator 608 forwards packets from the peer provider 612 to the peer consumer 602. If at least one of the slow heuristics succeeds, the peer consumer 602 and the peer provider 612 can have a P2P connection, and drop the peer coordinator 608 out of the middle (thereby potentially conserving infrastructure resources). If, on the other hand, all of the slow heuristics fail, the peer coordinator 608 can facilitate a connection through the peer intermediary 614. The peer provider 612 can then send packets to the peer intermediary 614 (represented by the arrow 620 in the example of FIG. 6) and the peer intermediary 614 can forward the packets to the peer consumer 602 (represented by the arrow 622 in the example of FIG. 6).

In another specific implementation, the peer coordinator 608 can facilitate a connection through the peer intermediary 614 before or in parallel with the execution of one or more slow heuristics. In this way, the peer coordinator can avoid consuming infrastructure resources by offloading the packet forwarding responsibility off onto a peer (i.e., the peer intermediary 614 in the example of FIG. 6). The peer intermediary 614 may or may not execute the slow heuristics as it forwards packets from the peer provider 612 to the peer consumer 602.

FIG. 7 depicts an example of a computer system 700. The system 700 may be a conventional computer system that can be used as a client computer system, such as a wireless client or a workstation, or a server computer system. The system 700 includes a device 702, I/O devices 704, and a display device 706. The device 702 includes a processor 708, a communications interface 710, memory 712, display controller 714, non-volatile storage 716, I/O controller 718, clock 722, and radio 724. The device 702 may be coupled to or include the I/O devices 704 and the display device 706.

The device 702 interfaces to external systems through the communications interface 710, which may include a modem or network interface. It will be appreciated that the communications interface 710 can be considered to be part of the system 700 or a part of the device 702. The communications interface 710 can be an analog modem, ISDN modem or terminal adapter, cable modem, token ring IEEE 802.5 interface, Ethernet/IEEE 802.3 interface, wireless 802.11 interface, satellite transmission interface (e.g. “direct PC”), WiMAX/IEEE 802.16 interface, Bluetooth interface, cellular/mobile phone interface, third generation (3G) mobile phone interface, code division multiple access (CDMA) interface, Evolution-Data Optimized (EVDO) interface, general packet radio service (GPRS) interface, Enhanced GPRS (EDGE/EGPRS), High-Speed Downlink Packet Access (HSPDA) interface, or other interfaces for coupling a computer system to other computer systems.

The processor 708 may be, for example, a conventional microprocessor such as an Intel Pentium microprocessor or Motorola power PC microprocessor. The memory 712 is coupled to the processor 708 by a bus 720. The memory 712 can be Dynamic Random Access Memory (DRAM) and can also include Static RAM (SRAM). The bus 720 couples the processor 708 to the memory 712, also to the non-volatile storage 716, to the display controller 714, and to the I/O controller 718.

The I/O devices 704 can include a keyboard, disk drives, printers, a scanner, and other input and output devices, including a mouse or other pointing device. The display controller 714 may control in the conventional manner a display on the display device 706, which can be, for example, a cathode ray tube (CRT) or liquid crystal display (LCD). The display controller 714 and the I/O controller 718 can be implemented with conventional well known technology.

The non-volatile storage 716 is often a magnetic hard disk, flash memory, an optical disk, or another form of storage for large amounts of data. Some of this data is often written, by a direct memory access process, into memory 712 during execution of software in the device 702. One of skill in the art will immediately recognize that the terms “machine-readable medium” or “computer-readable medium” includes any type of storage device that is accessible by the processor 708.

Clock 722 can be any kind of oscillating circuit creating an electrical signal with a precise frequency. In a non-limiting example, clock 722 could be a crystal oscillator using the mechanical resonance of vibrating crystal to generate the electrical signal.

The radio 724 can include any combination of electronic components, for example, transistors, resistors and capacitors. The radio is operable to transmit and/or receive signals.

The system 700 is one example of many possible computer systems which have different architectures. For example, personal computers based on an Intel microprocessor often have multiple buses, one of which can be an I/O bus for the peripherals and one that directly connects the processor 708 and the memory 712 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 712 for execution by the processor 708. A Web TV system, which is known in the art, is also considered to be a computer system, but it may lack some of the features shown in FIG. 7, such as certain input or output devices. A typical computer system will usually include at least a processor, memory, and a bus coupling the memory to the processor.

In addition, the system 700 is controlled by operating system software which includes a file management system, such as a disk operating system, which is part of the operating system software. One example of operating system software with its associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage 716 and causes the processor 708 to execute the various acts required by the operating system to input and output data and to store data in memory, including storing files on the non-volatile storage 716.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, understood to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present example also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, flash memory, magnetic or optical cards, any type of disk including floppy disks, optical disks, CD-ROMs, and magnetic-optical disks, or any type of media suitable for storing electronic instructions, and each coupled to a computer system bus.

The algorithms and displays presented herein are not inherently related to any particular computer or other Apparatus. Various general purpose systems may be used with programs in accordance with the teachings herein, or it may prove convenient to construct more specialized Apparatus to perform the required method steps. The required structure for a variety of these systems will appear from the description below. In addition, the present example is not described with reference to any particular programming language, and various examples may thus be implemented using a variety of programming languages.

What is claimed is:

1. A method comprising:
executing a first heuristic to obtain a first result;
updating a routing table in accordance with the first result;
executing a second heuristic to obtain a second result, wherein the first heuristic is a faster heuristic than the second heuristic;
updating the routing table in accordance with the second result when the execution of the second heuristic is successful.

2. The method of claim 1 further comprising executing the first heuristic and the second heuristic in parallel.

3. The method of claim 1 further comprising executing the second heuristic after executing the first heuristic.

4. The method of claim 1 further comprising routing a packet through a server after updating the routing table in accordance with the first result, but before updating the routing table in accordance with the second result.

5. The method of claim 1 further comprising peer-to-peer routing a packet after updating the routing table in accordance with the second result.

6. The method of claim 1 further comprising updating the routing table to include a peer intermediary when the execution of the second heuristic is unsuccessful.

7. A system comprising:
a fast connectivity node coupled to a peer-to-peer network;
a fast connectivity engine coupled to the fast connectivity node;
wherein, in operation,
the fast connectivity engine, using a first heuristic, establishes a path from a first peer to the fast connectivity node;
the fast connectivity engine, using the first heuristic, establishes a path to a second peer from the fast connectivity node;
the fast connectivity engine, using a second heuristic, establishes a path from the first peer to the second peer over the peer-to-peer network.

8. The system of claim 7 wherein the fast connectivity node is a second fast connectivity node, further comprising a first fast connectivity node, wherein, in operation:
the fast connectivity engine, using a third heuristic, establishes a path from the first peer to the first fast connectivity node;
the fast connectivity engine, using the third heuristic, establishes a path to the second peer from the first fast connectivity node.

9. The system of claim 7 wherein the fast connectivity engine, using a third heuristic, attempts to establish a path from the first peer to the second peer.

10. The system of claim 7 further comprising a peer coordinator, wherein the peer coordinator establishes a connection between the first peer and the second peer through a peer intermediary.

11. The system of claim 7 further comprising a peer coordinator, wherein the peer coordinator establishes a connection between the first peer and the second peer through a peer intermediary while the fast connectivity engine is using the second heuristic.

12. The system of claim 7 further comprising a platform security module, wherein a certificate in the platform security module identifies the first peer as having a trusted identity.

13. The system of claim 7 wherein the first heuristic is faster than the second heuristic.

14. The system of claim 7 further comprising a fast heuristics module, coupled to the fast connectivity node, wherein the first heuristic is embodied in the fast heuristics module.

15. The system of claim 7 further comprising a slow heuristics module, coupled to the fast connectivity node, wherein the second heuristic is embodied in the slow heuristics module.

16. A system comprising
an optimized routing engine, coupled to a peer network, including:
a routing table implemented in a computer-readable medium;
a peer-to-peer (P2P) route optimizer, coupled to the routing table, implemented in a computer-readable medium;
a fast heuristics module, coupled to the P2P route optimizer, implemented in a computer-readable medium;
a slow heuristics module, coupled to the P2P route optimizer, implemented in a computer-readable medium;
wherein, in operation,
the P2P route optimizer executes a first heuristic implemented in the fast heuristics module and updates the routing table in accordance with the results of the execution of the first heuristic;
the optimized routing engine uses the routing table to send a first packet to a peer;
the P2P route optimizer executes a second heuristic implemented in the slow heuristics module and updates the routing table in accordance with the results of the execution of the second heuristic;
the optimized routing engine uses the routing table to send a second packet in a P2P fashion to the peer.

17. The system of claim 16 further comprising a process implemented in a computer-readable medium, wherein, in operation, the process triggers the optimized routing engine to establish a path to the peer.

18. The system of claim 16 wherein the P2P route optimizer executes the second heuristic no earlier than the first heuristic.

19. The system of claim 16 further comprising a peer network coupled to the optimized routing engine, wherein the peer is on the peer network.

20. The system of claim 16 further comprising a peer network interface through which the optimized routing engine sends the first packet and the second packet to the peer.
